(19) United States
(12) Patent Application Publication
(10) Pub. No.: US 2026/0032079 A1
(43) Pub. Date: Jan. 29, 2026

(54) REMOTE FAULT LINKS PROPAGATION

(71) Applicant: MELLANOX TECHNOLOGIES, LTD., Yokneam (IL)

(72) Inventors: Eran Gil Beracha, Tel Aviv (IL); Aviv Kfir, Nili (IL); Ilya Vershkov, Rishon LeZion (IL)

(21) Appl. No.: 18/781,879

(22) Filed: Jul. 23, 2024

(51) Int. Cl. H04L 45/28; H04L 45/00

(52) U.S. Cl. CPC H04L 45/28; H04L 45/566

(57) ABSTRACT

Systems, nodes, and switches are provided. In one example, a system is described that includes one or more circuits to transmit one or more packets across a network toward a destination node, determine that all ports of an adaptive routing group are in a link down state, temporarily discontinue, for an amount of time after determining that all ports of the adaptive routing group are in the link down state, utilization of at least one switch in the network to transmit additional packets across the network to the destination node, and after the amount of time has elapsed, increase utilization of the at least one switch to transmit the additional packets across the network to the destination node.

### FIELD OF THE DISCLOSURE

The present disclosure is generally directed toward networking and, in particular, toward networking devices and methods of operating the same.

### BACKGROUND

Switches and similar network devices represent a core component of many communication, security, and computing networks. Switches are often used to connect multiple devices to form networks.

Devices including but not limited to personal computers, servers, and other types of computing devices, may be interconnected using network devices such as switches. Such interconnected entities may form a network enabling data communication and resource sharing among the nodes.

Links in networks are susceptible to failure for a variety of reasons. In a scenario where all links toward a specific destination node have failed (e.g., are down), a bandwidth loss and increased latency within the network is inevitable.

### BRIEF SUMMARY

In accordance with one or more embodiments described herein, systems, switches, nodes, and methods are described that help minimize the issues associated with link failure in a network. Specifically, embodiments of the present disclosure contemplate the ability to propagate or spread information of a link failure towards all relevant switches that could be impacted by the failure, thereby enabling such switches to reroute their traffic along a better route. Utilization of the approaches depicted and described herein enable the shift of bandwidth in a quick manner, while also enabling the gradual re-utilization of the link.

In accordance with at least some embodiments of the present disclosure, the proposed systems, devices, and methods aim to address routing decisions in a network responsive to faults in the network. A fault in the network resulting in blockage towards one destination can be mitigated by propagating information about the fault through the network and facilitating routing towards different routes. When a packet is received at a switch that knows all ports of a given adaptive routing group are in a link down state, the switch may reply to the original transmitter of the packet with a response indicating that “all links towards the destination are down.” The original transmitter of the packet receives the response from the switch and updates a local data structure to temporarily restrict the original transmitter from attempting to use that same switch again.

As time goes on and the original transmitter does not receive further information indicating that “all links towards the destination are down”, the original transmitter may incrementally adjust its local data structure to attempt packet transmissions through the switch that previously reported “all links towards the destination are down.” This process can continue unless another response is received indicating that “all links towards the destination are down” or until the original transmitter is utilizing the switch in a normal fashion.

When routing data to a group of equal ports in a network topology such as Fat-tree, Dragonfly or the like, adaptive routing can be utilized to monitor the amount of bandwidth sent from one switch to another on each of the ports. In a scenario where the entire group of ports is in link down state, such that no data can go through them, embodiments of the present disclosure contemplate the ability to propagate this information towards others switches in the network that may be affected by the same failure. As will be described, the proposed solution also contemplates the ability to monitor the link down state of the adaptive routing group (and ports therein) and shift the bandwidth towards other switches in a relatively short time (e.g., less than 1 us).

Embodiments of the present disclosure contemplate the ability for components of a system (e.g., switches, nodes, etc.) to cooperate with one another and intelligently react to link failures. Specifically, but without limitation, a system is contemplated to include a routing circuit to: transmit one or more packets across a network toward a destination node; determine that all ports of an adaptive routing group are in a link down state; temporarily discontinue, for an amount of time after determining that all ports of the adaptive routing group are in the link down state, utilization of at least one switch in the network to transmit additional packets across the network to the destination node; and after the amount of time has elapsed, increase utilization of the at least one switch to transmit the additional packets across the network to the destination node.

According to at least some aspects, the system may further include a data structure that stores, on a per-switch basis, a utilization value to be applied to an associated switch as part of transmitting the additional packets across the network.

According to at least some aspects, the utilization of the at least one switch is temporarily set to zero at least until the amount of time has elapsed.

According to at least some aspects, the utilization of the at least one switch is incrementally increased after the amount of time has elapsed.

According to at least some aspects, the utilization of the at least one switch is incrementally increased by a crawler according to a utilization restoration program.

According to at least some aspects, the network includes at least one of a tree network, a mesh network, a dragonfly network, and a hybrid network.

According to at least some aspects, the routing circuit determines that all ports of the adaptive routing group are in the link down state in response to receiving a message from the at least one switch, where the message includes an indication that all ports of the adaptive routing group are in the link down state.

According to at least some aspects, the message is transmitted from the at least one switch toward a source node including the routing circuit in response to the source node attempting to transmit a packet toward the destination node via the at least one switch.

According to at least some aspects, the indication is encoded on a header of the message transmitted from the at least one switch toward the source node.

According to at least some aspects, the at least one switch includes a spine switch.

Embodiments of the present disclosure also contemplate a switch, such as a leaf switch or a Top-of-Rack (TOR) switch to include: a network interface connecting the switch to a network; and a routing circuit to: transmit one or more packets across the network via the network interface toward a destination node; determine that all ports of an adaptive routing group are in a link down state; temporarily discontinue, for an amount of time after determining that all ports of the adaptive routing group are in the link down state, utilization of at least one other switch in the network to transmit additional packets toward the destination node; and after the amount of time has elapsed, increase utilization of the at least one other switch to transmit the additional packets toward the destination node.

According to at least some aspects, the switch may further include a data structure that stores, on a per-switch basis, a utilization value to be applied to an associated switch as part of transmitting the additional packets across the network.

According to at least some aspects, the routing circuit references the data structure prior to transmitting the one or more packets and the additional packets via the network interface.

According to at least some aspects, the utilization value to be applied to the associated switch is expressed, at least in part, based on a number of bits per spine state.

According to at least some aspects, the utilization of the at least one other switch is temporarily set to zero at least until the amount of time has elapsed.

According to at least some aspects, the utilization of the at least one other switch is incrementally increased after the amount of time has elapsed.

According to at least some aspects, the utilization of the at least one other switch is incrementally increased by a crawler according to a utilization restoration program.

Embodiments of the present disclosure also contemplate a switch, such as a leaf switch or a TOR switch, to include a fault reporting circuit to: detect when all ports of an adaptive routing group are in a link down state; receive a packet from a source node directed toward a destination node, where the packet is being routed via the adaptive routing group; and in response to receiving the packet while all ports of the adaptive routing group are in the link down state, provide a response message to the source node with an indication that all ports of the adaptive routing group are in a link down state.

According to at least some aspects, the indication is encoded on a header of the response message describing that all ports of the adaptive routing group are in the link down state.

According to at least some aspects, the fault reporting circuit continues to respond to packets being routed via the adaptive routing group with response messages indicating that all ports of the adaptive routing group are in a link down state until the fault reporting circuit detects at least one port of the adaptive routing group as no longer being in a link down state.

The solutions depicted and described herein may be applied to a switch, a router, or any other suitable type of networking device known or yet to be developed. Additional features and advantages are described herein and will be apparent from the following description and the figures.

### BRIEF DESCRIPTION OF THE SEVERAL VIEWS OF THE DRAWINGS

The present disclosure is described in conjunction with the appended figures, which are not necessarily drawn to scale:

FIG. 1 is a block diagram depicting an illustrative configuration of a switch in accordance with at least some embodiments of the present disclosure;

FIG. 2 illustrates a network of switches and nodes in accordance with at least some embodiments of the present disclosure;

FIG. 3 is a block diagram depicting an illustrative configuration of a node in accordance with at least some embodiments of the present disclosure;

FIG. 4 illustrates the network of switches and nodes having a failed link in accordance with at least some embodiments of the present disclosure;

FIG. 5 illustrates a data structure used in accordance with at least some embodiments of the present disclosure;

FIG. 6 illustrates details of a utilization restoration program in accordance with at least some embodiments of the present disclosure;

FIG. 7 is a flow diagram depicting a first method in accordance with at least some embodiments of the present disclosure; and

FIG. 8 is a flow diagram depicting a second method in accordance with at least some embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It is understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a printed circuit board (PCB), or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “automatic” and variations thereof, as used herein, refers to any appropriate process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate,” “compute,” and variations thereof, as used herein, are used interchangeably, and include any appropriate type of methodology, process, operation, or technique.

Various aspects of the present disclosure will be described herein with reference to drawings that are schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

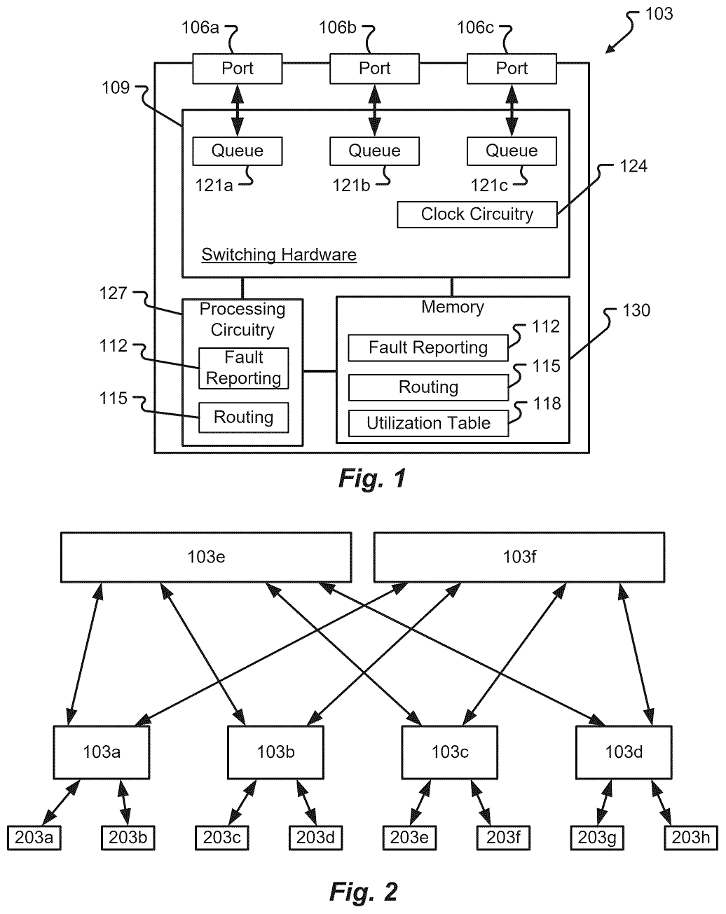

Referring now to FIGS. 1-8, various systems and methods for routing packets between switches and nodes will be described. The concepts of packet routing depicted and described herein can be applied to the routing of information from one computing device to another. The term packet as used herein should be construed to mean any suitable discrete amount of digitized information. The data being routed may be in the form of a single packet or multiple packets without departing from the scope of the present disclosure. Furthermore, certain embodiments will be described in connection with a system that is configured to make centralized routing decisions whereas other embodiments will be described in connection with a system that is configured to make distributed and possibly uncoordinated routing decisions. It should be appreciated that the features and functions of a centralized architecture may be applied or used in a distributed architecture or vice versa.

As illustrated in FIG. 1, a switch 103 as described herein may be a computing system comprising a number of ports 106a-c which may be used to interconnect with other switches 103 and/or computing systems and network devices, which may be referred to as nodes, to make up a network. For example, and as illustrated in FIG. 2, a switch 103 may be a spine switch 103c, 103f and/or a leaf switch 103a-d and may connect to other switches 103 and/or nodes 203a-h. Such a network of switches 103 and nodes 203 may be useful in various settings, from data centers and cloud computing infrastructures to artificial intelligence systems.

While a particular configuration of the network is illustrated in FIGS. 2 and 4, it should be appreciated that embodiments of the present disclosure are not so limited. In particular, other configurations of a network are also contemplated and may be utilized without departing from the scope of the present disclosure. Illustrative types of network configurations that may benefit from embodiments of the present disclosure include, without limitation, a tree network, a mesh network, a dragonfly network, and a hybrid network.

Switches 103, as described in greater detail herein, may enable communication between switches 103 and/or nodes 203. A switch 103 may be, for example, a switch, a network interface controller (NIC), or other device capable of receiving and sending data, and may act as a central node in the network. Switches 103 may be wired in a topology including spine switches, TOR switches, and/or leaf switches, for example. Switches 103 may be capable of receiving, processing, and forwarding data, e.g., packets, to appropriate destinations within the network, such as other switches 103 and/or nodes 203. In some implementations, a switch 103 may be included in a switch box, a platform, or a case which may contain one or more switches 103 as well as one or more power supply devices and other components. A TOR switch 103, as an example, may correspond to a specialized network switch that connects computing equipment in a data center rack to an in-rack network switch. As the name suggests, the TOR switch may be installed at the top of a server rack or switch rack, but they can be placed anywhere in the rack without departing from the scope of the present disclosure.

In some implementations, a switch 103 may comprise one or more ports 106a-c connected to one or more ports of other switches 103 and/or nodes 203. Processes, such as applications executed by nodes 203 may involve transmitting data to other nodes 203 of the network via switches 103. Data may flow through the network of switches 103 and nodes 203 using one or more protocols such as transmission control protocol (TCP), user datagram protocol (UDP), or Internet protocol (IP), for example. Each switch 103 may, upon receiving data from a node 203 or another switch 103, examine the data to identify a destination for the data and route the data through the network.

Data may be routed through the network in routes chosen at least in part based on routing information (e.g., a utilization table 118) stored in the switch 103 and/or node 203. For example, and as described in greater detail herein, a switch 103 may utilize routing 115 functionality capable of implementing an adaptive routing mechanism in which the switch 103 chooses a particular port 106a-c from which to forward a particular packet based on locally-maintained state data (e.g., the utilization table 118). The switch 103 may also be configured to forward a packet based on instructions contained in the packet (e.g., as instructed by another switch 103 or as instructed by a node 203 that initiated transmission of the packet (e.g., a source node 203)). As will be described in further detail herein, one or both of a switch 103 and a node 203 may be configured to store data in a locally-maintained table, such as a utilization table 118, indicating an amount of bandwidth, such as in terms of percentage and/or a data rate, for any possible route a packet may take to reach its destination.

Each node 203 may be a computing unit, such as a personal computer, server, or other computing device, and may be responsible for executing applications and performing data processing tasks. Nodes 203 as described herein may range from servers in a data center to desktop computers in a network, or to devices such as internet of things (IoT) sensors and smart devices as examples.

Each node 203 may for example include one or more processing circuits, such as graphics processing units (GPUs), central processing units (CPUs), application-specific integrated circuits (ASICs), field programmable gate arrays (FPGAs), or other circuitry capable of performing computations, as well as memory and storage resources to run software applications, handle data processing, and perform specific tasks as required. In some implementations, nodes 203 may also or alternatively include hardware such as GPUs for handling intensive tasks for machine learning, artificial intelligence (AI) workloads, or other complex processes.

For example, nodes 203 communicating via switches 103 may operate as a high-performance computing (HPC) cluster. A cluster of nodes 203 may comprise numerous interconnected servers, each equipped with CPUs and/or GPUs. The nodes 203 may provide computational horsepower for, as an example, training large-scale AI models or running complex scientific simulations. For AI and machine learning tasks, the nodes 203 may comprise one or more GPUs or other processing circuitry which may be capable of handling parallel processing requirements of neural networks and other applications.

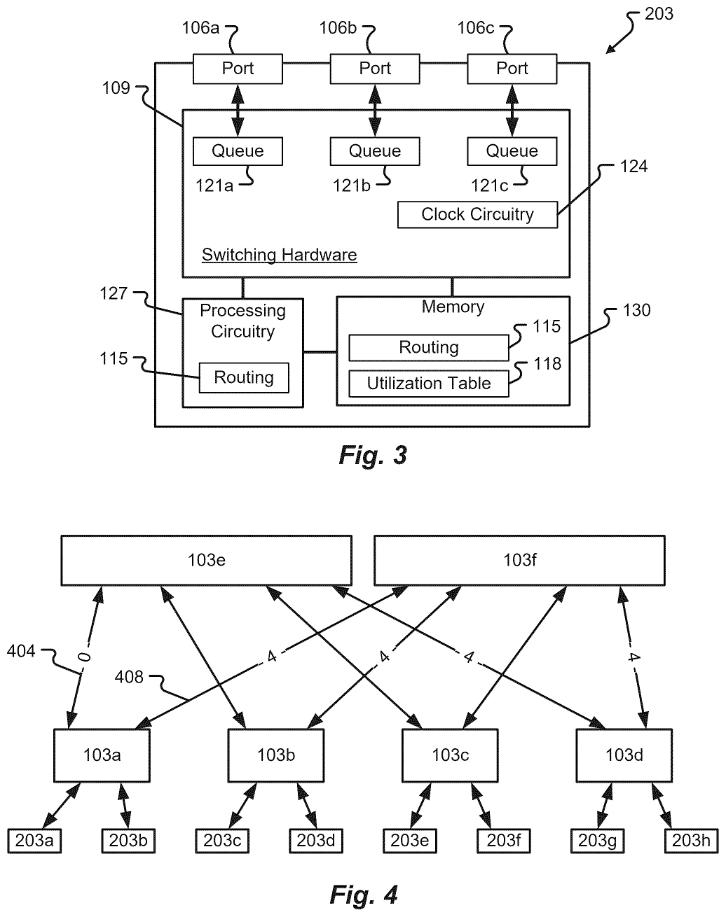

Nodes 203 may be client devices which, for example, engage in AI-related, research-related, and other processor-intensive tasks, and utilize a network of switches 103 and other nodes 203 to handle the computational loads and data throughput required by such intensive applications. Such nodes 203 may include, for example, workstations and personal computers used by researchers, data scientists, and professionals for developing, testing, and running AI models and research simulations. As can be seen in FIG. 3, the nodes 203 may include many components that are also included in a switch 103. For instance, a node 203 may include one or more ports 106a-c, switching hardware 109, processing circuitry 127, and memory 130. The nodes 203 may not necessarily need to include the same fault reporting 112 functionality as is included in the switches 103, but such functionality could be provided without departing from the scope of the present disclosure.

A switch 103 as described herein may in some implementations be as illustrated in FIG. 1. Such a switch 103 may include a plurality of ports 106a-c, queues 121a-c, switching hardware 109, processing circuitry 127, and memory 130. The ports 106a-c of a switch 103 may be capable of facilitating the transmission of data packets, or non-packetized data, into, out of, and through the switch 103. Such ports 106a-c may serve as interface points where network cables may be connected, connecting the switch 103 with other switches 103, and/or nodes 203.

Each port 106 may be capable of receiving incoming data packets from other devices and/or transmitting outgoing data packets to other devices. In some implementations, ports 106 may be configured to operate as either dedicated ingress or egress ports 106 or may be enabled to operate in a dual functionality capable of performing ingress and egress functions. For example, an egress port 106 may be used exclusively for sending data from the interconnect device and an ingress port 106 may be used solely for receiving incoming data into the switch.

Switching hardware 109 of a switch 103 may be capable of handling a received packet by determining a port 106 from which to send the packet and forwarding the packet from the determined port 106. Routing 115 functionality and a utilization table 118 may be utilized in support of making such routing decisions for a packet. More specifically, in addition to supporting the ability to transmit packets across the network the routing 115 functionality may also utilize the routing 115 functionality to determine that all ports of an adaptive routing group are in a link down state. This determination may be made in response to the switch 103 receiving a notification from another switch 103 in the network that all ports of an adaptive routing group are in a link down state. Upon making such a determination, the routing 115 functionality may also enable the switch 103 to temporarily discontinue, for an amount of time after determining that all ports of the adaptive routing group are in the link down state, utilization of at least one other switch in the network to transmit additional packets toward the destination node. The routing 115 functionality may then also increase utilization of the at least one other switch to transmit the additional packets toward the destination node after the amount of time has elapsed.

Each port 106 of a switch 103 may be associated with one or more queues 121a-c. When a packet, or data in any format, is to be sent from a port 106, the packet may be stored in a queue 121 associated with the port 106 until the port 106 is ready to send the packet. When congestion occurs, a backlog of data in queues 121 may build. By monitoring an amount of data in each queue, as described herein, the switch 103 may be enabled to determine a congestion or fault associated with each queue 121 and/or a congestion or fault associated with the ports 106 associated with the queues 121.

Switching hardware 109 of a switch 103 may also include clock circuitry 124. Clock circuitry 124 may be used by switching hardware 109 and/or other components of the switch 103 to implement functions such as aging timers and/or to implement a restoration program, as will be described in greater detail below. In some implementations, clock circuitry 124 may comprise a crystal oscillator or other circuit capable of providing an electrical signal at a particular frequency. Clock circuitry 124 may also or alternatively include one or more clock generators and other elements capable of providing counters and timers as described herein.

In support of the functionality of the switching hardware 109, processing circuitry 127 may be configured to control aspects of the switching hardware 109 to adaptive routing in relation to ARN packets. The processing circuitry 127 may in some implementations include a CPU, an ASIC, and/or other processing circuitry which may be capable of handling computations, decision-making, and management functions required for operation of the switch 103.

Processing circuitry 127 may be configured to handle management and control functions of the switch 103, such as setting up routing tables, configuring ports, and otherwise managing operation of the switch 103. Processing circuitry 127 may execute software and/or firmware to configure and manage the switch 103, such as an operating system and management tools. In some implementations, the processing circuitry 127 may include fault reporting 112 functionality that enables the switch 103 to report faults within the network. The processing circuitry 127 may also include routing 115 functionality that enables the switch 103 to make routing decisions for packets received at the switch 103. The routing 115 functionality may utilize adaptive routing groups and/or other routing schemes as part of routing packets within the network.

Portions of the processing circuitry 127 that are configured to implement the fault reporting 112 functionality may be referred to as a fault reporting circuit. Portions of the processing circuitry 127 that are configured to implement the routing 115 functionality may be referred to as a routing circuit. Alternatively or additionally, the fault reporting 112 functionality and/or routing 115 functionality may be provided as instructions stored in memory 130. When the processing circuitry 127 executes the fault reporting 112 functionality stored as instructions in memory 130, then the processing circuitry 127 may be considered to be operating as a fault reporting circuit. When the processing circuitry 127 executes the routing 115 functionality stored as instructions in memory 130, then the processing circuitry 127 may be considered to be operating as a routing circuit. Thus, whether implemented as software, hardware, or a combination thereof, the processing circuitry 127, when providing fault reporting 112 functionality may be considered to include a fault reporting circuit and when providing routing 115 functionality may be considered to include a routing circuit.

The fault reporting circuit implemented by the processing circuitry 127 may be configured to detect when all ports 106 belonging to an adaptive routing group are in a link down state. The fault reporting circuit may also be configured to receive a packet. The packet may be received from another switch 103 or from a source node (e.g., one node 203) directed toward a destination node (e.g., another node 203), when the packet is being routed via the adaptive routing group. In response to receiving the packet while all ports 106 of the adaptive routing group are in the link down state, the fault reporting circuit may further provide a response message to the sender of the packet (e.g., the other switch 103 or the source node 203) with an indication that all ports 106 of the adaptive routing group are in a link down state.

In some embodiments, the fault reporting circuit implemented by the processing circuitry 127 may encode the indication that all ports 106 of the adaptive routing group are in a link down state on a header of the response message. Thus, the header of the response message may describe that all ports 106 of the adaptive routing group are in the link down state. As will be described in further detail herein, the fault reporting circuit implemented by the processing circuitry 127 may continue to respond to packets being routed via the adaptive routing group with response messages indicating that all ports 106 of the adaptive routing group are in a link down state until the fault reporting circuit detects at least one port 106 of the adaptive routing group as no longer being in a link down state.

Memory 130 as described herein may comprise one or more memory elements capable of storing configuration settings, fault reporting 112 functionality in the form of instructions, routing 115 functionality in the form of instructions, a utilization table 118, application data, operating system data, and other data. Such memory elements may include, for example, random access memory (RAM), dynamic RAM (DRAM), flash memory, non-volatile RAM (NVRAM), ternary content-addressable memory (TCAM), static RAM (SRAM), and/or memory elements of other formats.

For example, as illustrated in FIG. 2, a number of switches 103a-f may be interconnected and also connected to nodes 203a-h to form a network. Each arrow in FIG. 2 may represent any number of one or more connections between the various elements. For example, ports of a first switch 103a may be connected to one or more ports of a second switch 103e, one or more ports of a sixth switch 103f, and one or more ports of each of nodes 203a and 203b. Each connection between a switch 103 and another switch 103 or node 203 may be used to carry multiple flows. Flows may also be static flows or adaptive routing flows. Static flows may be flows which cannot be rerouted via different routes through the network while adaptive routing flows may be flows which can be routed via a variety of different routes to reach the proper destination. As an example, each node 203a-h may transmit static flows and/or adaptive flows to other nodes 203a-h via the switches 103a-f.

As should be appreciated, the specific interconnections of the switches 103a-f and nodes 203a-h illustrated by FIG. 2 are provided for illustration purposes only and should not be considered as limiting in any way. While the network illustrated in FIG. 2 only includes 2 layers of switches 103, it should be appreciated additional layers may be introduced and switches may be interconnected in any conceivable manner. For example, in some implementations, a network as described herein may contain multiple switches 103 interconnected in a topology such as a Clos network, a fat tree topology network, a mesh network, a dragonfly network, and a hybrid network, etc.

In a network of switches as described herein, link failure or network congestion is a problem that may occur in the network. For example, in the network illustrated in FIG. 4, a scenario is shown in which a first communication link 404 connecting a first switch 103a with a fifth switch 103e is experiencing a problem and communications over the first communication link 404 are not available. In particular, the first communication link 404 may be down due to a mechanical failure, due to congestion, or for some other reason. A second link 408, however, is still available to connect the first switch 103a with a higher-level switch, such as a sixth switch 103f.

In the scenario depicted, the fault reporting 112 functionality of the fifth switch 103e or first switch 103a may detect that the first communication link 404 is experiencing link failure. In some embodiments, the switch 103a or 103e may determine that all ports of the adaptive routing group belonging to the first communication link 404 are in a link down state. If the first switch 103a or fifth switch 103e receives a packet from a source node (e.g., any node 203a-h) that is attempting to traverse the first communication link 404, the switch receiving the packet may utilize the fault reporting 112 functionality to prepare and send a response to the source node indicating that all ports of the adaptive routing group belonging to the first communication link 404 are in a link down state.

When routing data to a group of equal ports in a network topology such as Fat-tree, Dragonfly or else, adaptive routing can be used to monitor the amount of bandwidth sent from one switch to another on each of the ports. In a scenario where the entire group of ports is in link down state, such that no data can go through them, this information may be propagated towards others switches in the network that may be affected by the link down state. For example, referring to FIG. 4, if the eighth node 203h wants to send traffic to the first node 203a, the eighth node 203h can do so only through the sixth switch 103f since all links are down between the fifth switch 103e and the first node 203a. Since the link down is an information remote to the fourth switch 103d, the fourth switch 103d may keep sending traffic towards the fifth switch 103e that is destined to the first node 203a since the information about the link down didn't arrive yet. To solve such problems, embodiments of the present disclosure contemplate enabling the fifth switch 103e and/or the first switch 103a to monitor the link down (e.g., the failed first communication link 404) and shift the bandwidth towards other switches 103 in a relatively short time (e.g., less than 1 us).

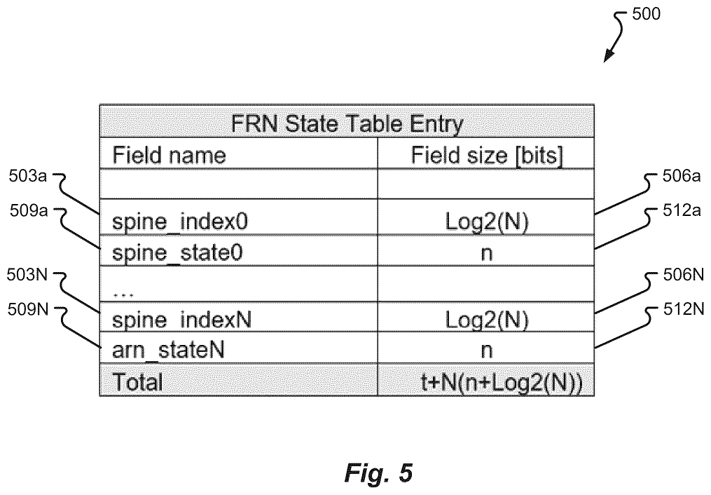

Referring now to FIG. 5, additional details of a data structure 500 that may be used to support the fault reporting and response functionality will be described in accordance with at least some embodiments of the present disclosure. More specifically, the data structure 500 may be part of the utilization table 118 stored in memory 130 of a switch 103 or node 203. In some embodiments, the data structure 500 stored, on a per-switch basis, a utilization value to be applied to an associated switch as part of transmitting packets across the network and toward the associated switch. The data structure 500 may be referenced by the routing circuit prior to transmitting the packet(s) via a port 106.

The utilization value may be expressed in a number of ways. In some embodiments, the utilization value to be applied to the associated switch is expressed, at least in part, based on a number of bits per switch (e.g., spine switch) state. In some embodiments, the data structure 500 comprises a granularity of one set of entries per destination switch 103. For instance, in the network illustrated in FIGS. 2 and 4, the fourth switch 103d would maintain a data structure 500 having three sets of entries, one per destination switch (e.g., the first switch 103a, the second switch 103b, and the third switch 103c).

The illustrated embodiment comprises a set of N entries with N=3, where each set of entries includes a spine index field 503 with a corresponding spine index value 506 as well as a spine state field 509 with a corresponding spine state value 512. Each set of entries may be associated with a different destination switch 103. The first set of entries 503a, 506a, 509a, 512a may be associated with the first switch 103a. The Nth set of entries 503N, 506N, 509N, 512N may be associated with the third switch 103c. This granularity is provided to support improving the efficiency of routing decisions within the network, namely by allowing other switches 103 to be aware of failed communication links, such as the first communication link 404.

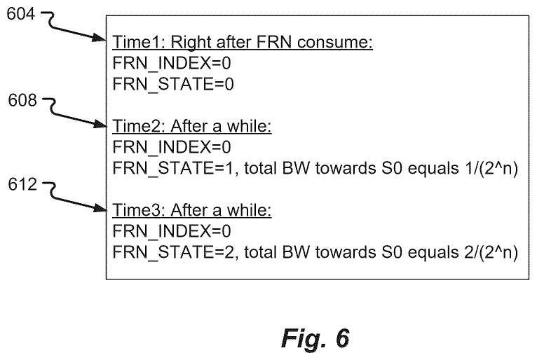

Referring now to FIG. 6, additional details of a process followed by a routing circuit will be described in accordance with at least some embodiments of the present disclosure. FIG. 6 specifically illustrates details of a utilization restoration program that may be implemented by a routing circuit in accordance with at least some embodiments of the present disclosure. In some embodiments, one switch 103 in the network may notify another switch 103 in the network that all links towards a destination node 203 are in a link down state. For example, the fifth switch 103e may notify the second switch 103b that communication link 404 is in a down state. When a switch 103 (e.g., the second switch 103b) is notified of such a state (e.g., receives a response packet from the fifth switch 103c), the second switch 103b may set the “Spine weight” to a value of zero in the data structure 500 in association with the fifth switch 103c, indicating that all packets that may be sent through the fifth switch 103e towards a destination (e.g., the first node 203a), will be given 0% bandwidth towards it. In the illustrated example, all packets from the fifth switch 103e towards the first node 203a will be given 0% BW to be sent through the fifth switch 103e and 100% to be sent through the sixth switch 103f (step 604).

The routing circuit of the second switch 103b may further implement a crawler to execute a utilization restoration program. The utilization restoration program may include iterating on the data structure 500 and every T time will increase the value of “spine weight” by 1, including that

$$\frac{1}{{2}^{num \_ of \_ bits \_ per \_ spine \_ state}}$$

BW will be incremented to it (step 608).

If the link down state of all ports hasn't yet been resolved yet, a new packet indicating of “all links towards the destination are down” will be sent from the fifth switch 103e to the second switch 103b and the “Spine weight” will be reduced back to zero (step 604). In some embodiments, the indication is encoded on a header of the response message describing that all ports of the adaptive routing group are in the link down state.

If the link down state of some of the ports was resolved, the fifth switch 103e may be configured to generate a message indicating of problem resolved and the second switch 103b will increase the BW by

$$\frac{1}{{2}^{num \_ of \_ bits \_ per \_ spine \_ state}}$$

(step 612). This utilization restoration program may continue to be implemented until such time as the utilization associated with the communication link 404 is back to a full utilization value.

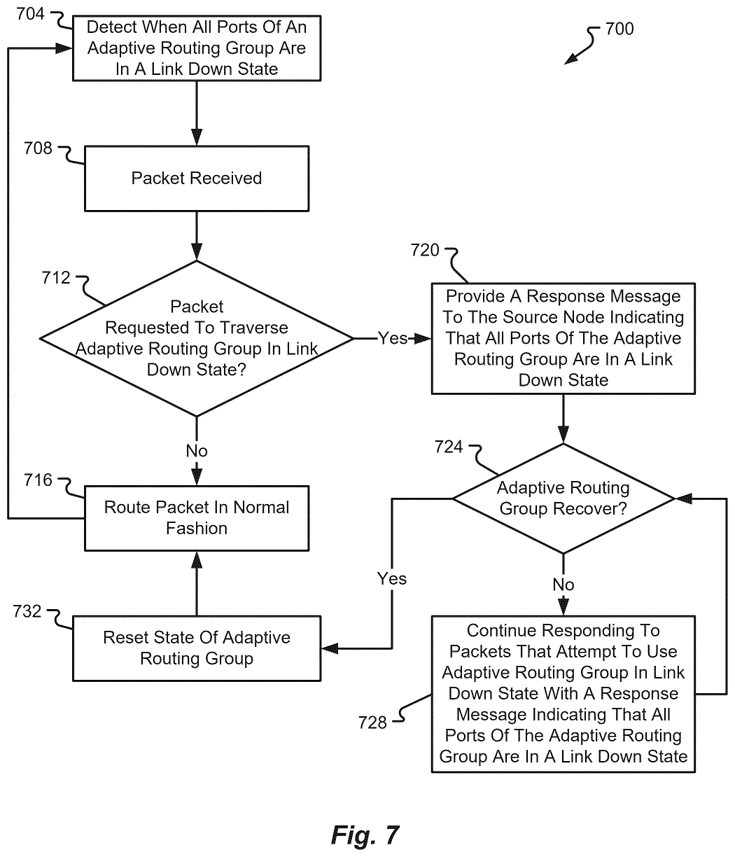

Referring now to FIG. 7, a first method 700 will be described in accordance with at least some embodiments of the present disclosure. While the method 700 will be described in connection with operations of a switch 103, it should be appreciated that a node 203 may implement some or all of the steps of the method 700 without departing from the scope of the present disclosure.

The method 700 begins when a fault reporting circuit of a switch detects when all ports of an adaptive routing group are in a link down state (step 704). The switch may detect such a condition in response to determining that packets sent on a particular communication link are experiencing excessive delay or the communication link is otherwise congested and performing at less than an acceptable level.

The method 700 may continue when the switch that detected the state of the communication link receives a packet from another switch or node that is directed to be transmitted over the compromised communication link (step 708). Upon receiving such a packet and determining that the packet is requested to traverse the adaptive routing group in the link down state (step 712), the method 700 continues by providing a response message back to the device that transmitted the packet (step 720). In particular, the switch that received the packet may respond back to the device (e.g., switch 103 or node 203) that was the source of the packet. If, however, the packet was received and the query of step 712 is answered negatively (e.g., because the communication link is not in a down state), then the method 700 may continue with the switch routing the packet in the normal fashion (step 716).

Referring back to step 720, after the switch responds to the sender of the packet with a response message, the method 700 may continue by determining if the adaptive routing group has recovered (step 724). In other words, the switch 103 that received the previous packet may monitor the communication link to determine if any aspects of the communication link have improved such that the communication link is available for use.

If the query of step 724 is answered negatively, then the switch 103 will continue responding to packets that attempt to use the adaptive routing group in the link down state with a response message indicating that all ports of the adaptive routing group are in a link down state (step 728). If the query of step 724 is answered affirmatively, then the switch 103 may reset the state of the adaptive routing group (step 732) and begin routing packets in the normal fashion (step 716).

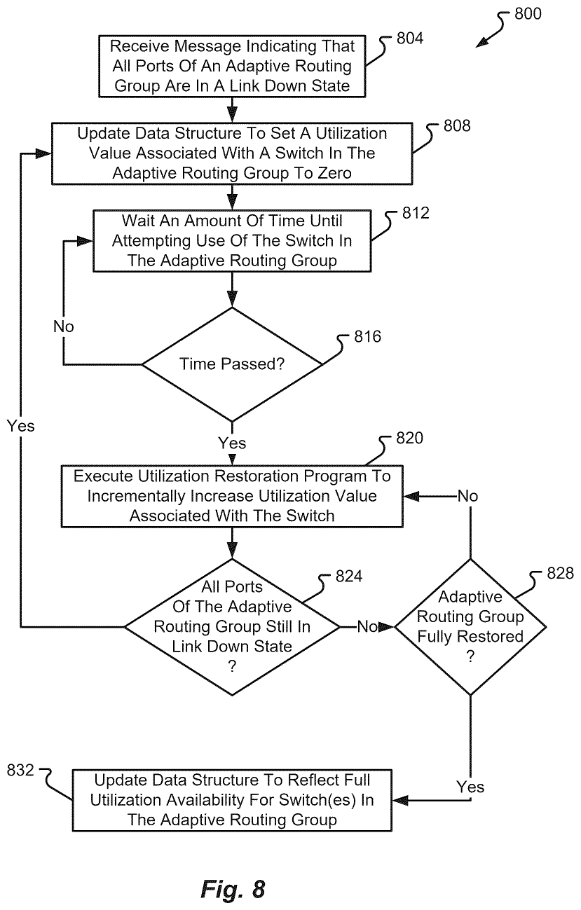

Referring now to FIG. 8, a second method 800 will be described in accordance with at least some embodiments of the present disclosure. While the method 800 will be described in connection with operations of a switch 103, it should be appreciated that a node 203 may implement some or all of the steps of the method 800 without departing from the scope of the present disclosure.

The method 800 begins when a switch 103 (e.g., a receiving switch 103) receives a message indicating that all ports of an adaptive routing group are in a link down state (step 804). In some embodiments, the message received by the receiving switch 103 in step 804 may correspond to a response message transmitted by another switch 103 in response to the other switch 103 receiving a packet that was attempting to traverse the communication link that is in the link down state. The packet may have been transmitted by the receiving switch 103.

The method 800 may continue with the receiving switch 103 updating a data structure to set a utilization value associated with the other switch 103 to a utilization value of zero (step 808). As an example, the receiving switch 103 may update a data structure 500, such as a utilization table 118, to indicate that the other switch 103 should not be used to attempt packet transmission to another node 203.

The method may continue with the receiving switch 103 modifying the use of its routing circuit to wait an amount of time until attempting use of the other switch 103 (step 812). The receiving switch 103 may wait for the amount of time to elapse (step 816), at which point the receiving switch 103 may begin executing a utilization restoration program to incrementally increase the utilization value associated with the other switch 103 (step 820). As the receiving switch 103 implemented the utilization restoration program, the receiving switch 103 may continue determining if all ports of the adaptive routing group are still in the link down state (step 824). If this query is ever answered affirmatively, then the method 800 may return to step 808.

If, however, the query of step 824 is eventually answered negatively, then the method 800 may continue with the receiving switch 103 determining if the adaptive routing group has been fully restored (step 828). If the query of step 828 is answered negatively, then the receiving switch 103 may continue to execute the utilization restoration program where the utilization value associated with the other switch continues to be incremented, thereby increasing the utilization value associated with the other switch (step 820).

Once the receiving switch 103 has completed the utilization restoration program and the adaptive routing group has been fully restored (step 828), the method 800 may continue to update the data structure 500 to reflect that the other switch has a full utilization availability (step 832).

It is to be appreciated that any feature described herein can be claimed in combination with any other feature(s) as described herein, regardless of whether the features come from the same described embodiment.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A system, comprising:
a routing circuit to:
transmit one or more packets across a network toward a destination node;
determine that all ports of an adaptive routing group are in a link down state;
temporarily discontinue, for an amount of time after determining that all ports of the adaptive routing group are in the link down state, utilization of at least one switch in the network to transmit additional packets across the network to the destination node; and
after the amount of time has elapsed, increase utilization of the at least one switch to transmit the additional packets across the network to the destination node.

2. The system of claim 1, further comprising:
a data structure that stores, on a per-switch basis, a utilization value to be applied to an associated switch as part of transmitting the additional packets across the network.

3. The system of claim 1, wherein the utilization of the at least one switch is temporarily set to zero at least until the amount of time has elapsed.

4. The system of claim 1, wherein the utilization of the at least one switch is incrementally increased after the amount of time has elapsed.

5. The system of claim 4, wherein the utilization of the at least one switch is incrementally increased by a crawler according to a utilization restoration program.

6. The system of claim 1, wherein the network comprises at least one of a tree network, a mesh network, a dragonfly network, and a hybrid network.

7. The system of claim 1, wherein the routing circuit determines that all ports of the adaptive routing group are in the link down state in response to receiving a message from the at least one switch, wherein the message comprises an indication that all ports of the adaptive routing group are in the link down state.

8. The system of claim 7, wherein the message is transmitted from the at least one switch toward a source node comprising the routing circuit in response to the source node attempting to transmit a packet toward the destination node via the at least one switch.

9. The system of claim 8, wherein the indication is encoded on a header of the message transmitted from the at least one switch toward the source node.

10. The system of claim 1, wherein the at least one switch comprises a spine switch.

11. A switch, comprising:
a network interface connecting the switch to a network; and
a routing circuit to:
transmit one or more packets across the network via the network interface toward a destination node;
determine that all ports of an adaptive routing group are in a link down state;
temporarily discontinue, for an amount of time after determining that all ports of the adaptive routing group are in the link down state, utilization of at least one other switch in the network to transmit additional packets toward the destination node; and
after the amount of time has elapsed, increase utilization of the at least one other switch to transmit the additional packets toward the destination node.

12. The switch of claim 11, further comprising:
a data structure that stores, on a per-switch basis, a utilization value to be applied to an associated switch as part of transmitting the additional packets across the network.

13. The switch of claim 12, wherein the routing circuit references the data structure prior to transmitting the one or more packets and the additional packets via the network interface.

14. The switch of claim 13, wherein the utilization value to be applied to the associated switch is expressed, at least in part, based on a number of bits per spine state.

15. The switch of claim 11, wherein the utilization of the at least one other switch is temporarily set to zero at least until the amount of time has elapsed.

16. The switch of claim 11, wherein the utilization of the at least one other switch is incrementally increased after the amount of time has elapsed.

17. The switch of claim 16, wherein the utilization of the at least one other switch is incrementally increased by a crawler according to a utilization restoration program.

18. A switch, comprising:
a fault reporting circuit to:
detect when all ports of an adaptive routing group are in a link down state;
receive a packet from a source node directed toward a destination node, wherein the packet is being routed via the adaptive routing group; and
in response to receiving the packet while all ports of the adaptive routing group are in the link down state, provide a response message to the source node with an indication that all ports of the adaptive routing group are in a link down state.

19. The switch of claim 18, wherein the indication is encoded on a header of the response message describing that all ports of the adaptive routing group are in the link down state.

20. The switch of claim 18, wherein the fault reporting circuit continues to respond to packets being routed via the adaptive routing group with response messages indicating that all ports of the adaptive routing group are in a link down state until the fault reporting circuit detects at least one port of the adaptive routing group as no longer being in a link down state.
